(19) United States
(12) Patent Application Publication
(10) Pub. No.: US 2026/0025904 A1
(43) Pub. Date: Jan. 22, 2026

(54) RF RESONATOR WITH HIGH Q VALUE FOR ION BEAM ACCLELERATION

(71) Applicant: Axcelis Technologies, Inc., Beverly, MA (US)

(72) Inventors: Wilhelm Platow, Newburyport, MA (US); Shu Satoh, Byfield, MA (US); Patrick Mayfield, Malden, MA (US); Tomoya Nakatsugawa, Georgetown, MA (US); Neil Bassom, Hamilton, MA (US)

(21) Appl. No.: 19/275,131

(22) Filed: Jul. 21, 2025

Related U.S. Application Data
(60) Provisional application No. 63/673,848, filed on Jul. 22, 2024.

(51) Int. Cl. H05H 7/18

(52) U.S. Cl. CPC H05H 7/18

(57) ABSTRACT

A resonator is provided for an RF linear accelerator and has a housing defining a housing volume. An electrode is configured to accelerate ions and is disposed external to the housing volume. A tube is electrically conductive and has an electrode portion and a coil portion. The electrode portion is electrically coupled to the electrode. The tube is generally defined by a tube diameter. The coil portion has a predetermined shape when viewed along a first axis and is disposed within the housing volume. The coil portion defines a coil length when viewed perpendicular to the first axis. The coil portion of the tube is turned three or fewer turns about the first axis. The coil length is less than approximately six times the tube diameter, and six times the tube diameter is less than approximately 1500 mm.

### REFERENCE TO RELATED APPLICATIONS

This application claims the benefit of U.S. Provisional Application Ser. No. 63/673,848 filed Jul. 22, 2024, entitled, “RF RESONATOR WITH HIGH Q VALUE FOR ION BEAM ACCELERATION”, the contents of all of which are herein incorporated by reference in their entirety.

### FIELD

The present disclosure relates generally to ion implantation systems, and more specifically to an improved RF high voltage generator or RF resonator apparatus having a high Q factor.

### BACKGROUND

A sinusoidal electric field has long been used for ion beam acceleration since the invention of linear RF accelerators and the cyclotron. In order to accelerate ions to an energy of several MeV, RF accelerators have been developed to repeatedly accelerate the ion beam, at a relatively low energy gain of approximately 100 keV at each stage, in order to avoid difficulties in producing a mega-volt DC voltage. However, the RF accelerators still require generation of an RF voltage of approximately 100 kV peak voltage, which is achieved by the use of high-Q resonators for conversion of RF power (typically at low impedance of 50 ohms) into high RF voltages.

### SUMMARY

The present disclosure overcomes limitations of the prior art by providing a system, apparatus, and method for a radio frequency (RF) resonator having a high Q factor for an ion implantation system, thereby improving performance capabilities of the ion implantation system. Accordingly, the following presents a simplified summary of the disclosure in order to provide a basic understanding of some aspects of the disclosure. This summary is not an extensive overview of the disclosure. It is intended to neither identify key or critical elements of the invention nor delineate the scope of the invention. Its purpose is to present some concepts of the disclosure in a simplified form as a prelude to the more detailed description that is presented later.

In accordance with one exemplary aspect, a resonator for an RF linear accelerator is provided, wherein the resonator comprises an electrode configured to accelerate ions and a tube that is electrically conductive and comprises an electrode portion and a coil. The electrode portion, for example, is electrically coupled to the electrode. The tube, for example, is generally defined by a tube diameter, wherein the coil has a predetermined shape when viewed along a first axis. The coil further defines a coil length when viewed along a second axis that is perpendicular to the first axis. The coil, for example, comprises three or fewer turns n of the tube about the first axis, and the coil length is less than approximately six times the tube diameter, wherein the tube diameter is less than approximately 1500 mm.

The resonator, for example, can further comprise a housing, wherein at least the coil of the tube is disposed within the housing, and wherein the electrode is disposed external to housing. The housing, for example, can have a housing length when viewed along the second axis, and wherein the housing length is less than approximately 2000 mm. In another example, the coil has a coil radius when viewed along the first axis, wherein the housing length is less than or equal to approximately 1.5 times the coil radius. In another example, the housing has a housing radius R_{housing} when viewed along the first axis, wherein the housing length is less than or equal to approximately 0.5 times the housing radius R_{housing}.

The above summary is merely intended to give a brief overview of some features of some embodiments of the present disclosure, and other embodiments may comprise additional and/or different features than the ones mentioned above. In particular, this summary is not to be construed to be limiting the scope of the present application. Thus, to the accomplishment of the foregoing and related ends, the disclosure comprises the features hereinafter described and particularly pointed out in the claims. The following description and the annexed drawings set forth in detail certain illustrative embodiments of the disclosure. These embodiments are indicative, however, of a few of the various ways in which the principles of the disclosure may be employed. Other objects, advantages and novel features of the disclosure will become apparent from the following detailed description of the disclosure when considered in conjunction with the drawings.

### BRIEF DESCRIPTION OF THE DRAWINGS

FIG. 1 is a perspective view of an example RF resonator.

FIG. 2 illustrates a cross-sectional view of the example RF resonator of FIG. 1.

FIG. 3 is a perspective view of an example RF resonator in accordance with various aspects of the present disclosure.

FIG. 4A is a side view of an example coil for an RF resonator in accordance with various aspects of the present disclosure.

FIG. 4B is a top view of the example coil of FIG. 4A in accordance with various aspects of the present disclosure.

FIG. 5A is a perspective view of an example resonator having a single turn coil in accordance with various aspects of the present disclosure.

FIG. 5B is a perspective view of another example resonator having a single turn coil in accordance with various aspects of the present disclosure.

FIG. 6A is a perspective view of an example linear accelerator having resonators with single turn coils in accordance with various aspects of the present disclosure.

FIG. 6B is a side view of the example linear accelerator of FIG. 6A in accordance with various aspects of the present disclosure.

FIG. 7A is a front perspective view of an example resonator having a spiral coil in accordance with various aspects of the present disclosure.

FIG. 7B is a side perspective view of the example resonator of FIG. 7A in accordance with various aspects of the present disclosure.

### DETAILED DESCRIPTION

The present disclosure is directed generally toward semiconductor processing systems, and more particularly, to a radio frequency (RF) resonator and coil that can be associated with an ion implantation system. Accordingly, the present disclosure will now be described with reference to the drawings, wherein like reference numerals may be used to refer to like elements throughout. It should be understood that the description of these aspects are merely illustrative and that they should not be interpreted in a limiting sense. In the following description, for purposes of explanation, numerous specific details are set forth in order to provide a thorough understanding of the present disclosure. It will be evident to one skilled in the art, however, that the present disclosure may be practiced without these specific details.

Resonators provide high RF voltage to electrodes in a linear accelerator to accelerate a beam of ions (called an ion beam) as the ions pass through an acceleration tube. Typically, the ion beam is first longitudinally compressed into a multitude of bunches and then accelerated through a plurality of acceleration stages, whereby when timed appropriately, the bunches are at an entrance of a first stage of the acceleration tube at a predetermined timing and are accelerated into the first stage of the acceleration tube. With the first stage of the acceleration tube having a predetermined length, the bunches of ions exit the first stage of the acceleration tube at a desired time to proceed with a second stage of acceleration, and so on.

Each stage of the acceleration tube is operably coupled to a resonator. The resonator comprises a coil positioned within a housing, whereby the resonator extends axially from the acceleration tube. Radio frequency (RF) power applied to the coil results in a large amount of stored energy and builds a standing wave with a large amplitude, thus producing a high RF voltage at an electrode at a first end of the coil. The coil is electrically coupled the housing, whereby the housing is at ground potential and a second end of the coil can be electrically free.

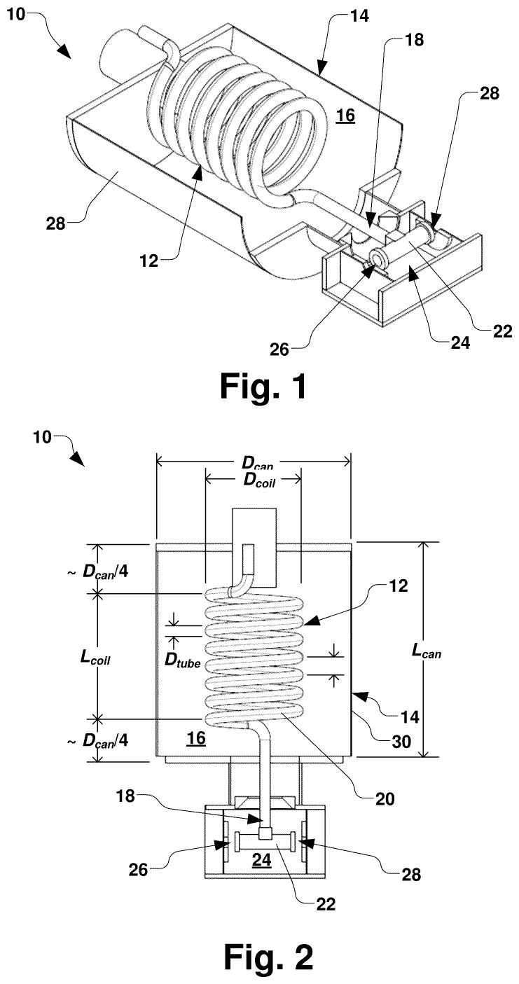

FIG. 1 illustrates an exemplary RF resonator 10 (e.g., a 13.56 MHz resonator), whereby a resonance circuit 12 of the resonator system is housed in a housing 14 (e.g., a generally leak-tight aluminum cylindrical housing, also referred to as a “can”) which generally defines a resonator gas environment 16 (e.g., an environment filled with a resonator gas such as sulfur hexafluoride (SF₆)). The resonator gas environment 16 generally prevents internal high voltage flashover, high voltage arcing, and plasma ignition. RF high voltage is developed on an open-end side 18 of a resonance coil 20, which drives an accelerator electrode 22 (an accelerating tube) located in a high vacuum environment 24 associated therewith. As ion bunches (not shown) pass through the accelerator electrode 22, the ion bunches are accelerated via the electric RF field proximate to an entrance wall 26 and an exit wall 28 associated with the accelerator electrode, provided a velocity and a flight time associated therewith matches a length of the accelerator electrode.

The present disclosure appreciates that a high energy RF linear accelerator (referred to generally as RF LINACs) configured to accelerate low mass-to-charge ratio ions can benefit from higher frequency resonators due to reduced lengths of the accelerator electrode 22. However, doubling the frequency from 13.56 MHz to 27.12 MHz also requires a doubling of the quality factor Q (a dimensionless measure of the damping, also called the Q factor) in order to achieve the same RF amplitudes and maximum energy. The present disclosure proposes a novel resonator configuration that advantageously doubles the Q factor to provide desired energies.

For example, the quality factor Q of a resonator 10 can be defined as:

$$Q = \frac{ω W}{P} , \qquad ( 1 )$$

whereby P is power lost to walls 30 of the resonator, ω is the angular resonance frequency, and W the stored energy. RF amplitude Vₚₚ (also called peak-to-peak voltage) of the resonator 10 is:

$${V}_{p p} = \sqrt{\frac{2 QP}{C ω}} , \qquad ( 2 )$$

where C is the capacitance of the resonator. The capacitance C is dominated by the accelerator electrode 22 and its close proximity to the entrance wall 26 and exit wall 28 in the LINAC and thus remains approximately constant when doubling the angular resonance frequency @, and where

$$ω = 2 π f , \qquad ( 3 )$$

whereby f is the resonance frequency.

Equation (2) for Vₚₚ provides that when doubling the angular resonance frequency ω, it is desirable to double the quality factor Q (also called the Q-factor), since the capacitance C remains approximately constant, and the power P supplied the resonator 10 cannot exceed a predetermined maximum value in order to avoid arcing and break down of ceramic insulators due to loss tangent and RF heating issues causing reliability concerns. When scaling the angular resonance frequency for a resonator 10 by a scaling factor X, the Q-factor should also change by the scaling factor X in order to maintain large RF amplitudes, and thus maximum acceleration, for a minimum number of resonators to achieve a small footprint for the LINAC.

Conventional design guides are available for helical resonators, such as in “Handbook of Filter Synthesis” by Anatol I. Zverev, page (1967), John Wiley & Sons, Inc. which provide ranges for the resonator parameters. Using such conventional design guides, and adjusting for the capacitance of the RF electrode, a resonance frequency f=27.12 MHz can be ascertained. However, using the conventional design guides, the Q-factor of such a design is only half of what is desirable (e.g., the same Q-factor as for an angular resonant frequency of 13.56 MHz). Since a resonator is resonant at the angular resonance frequency ω as:

$$ω = \frac{1}{\sqrt{LC}} , \qquad ( 4 )$$

and because the capacitance C is roughly unchangeable when using the same acceleration electrode, the inductance L is also a constant. However, the present disclosure considers that the inductance L of a multi-turn coil or solenoid can be defined as:

$$L = \frac{μ {n}^{2} π {D}_{coil}^{2}}{4 {L}_{coil}} , \qquad ( 5 )$$

and that when using the permeability μ, number of turns n of the coil 20, coil diameter D_{coil}, and coil length L_{coil}, the same inductance L can be achieved by reducing the number of turns, while increasing the coil diameter D_{coil}. In a simulation, the inventors varied the number of turns n and coil diameter D_{coil}, while keeping the inductance L constant resulted in an increased Q-factor, while keeping the angular resonance frequency ω fixed. While not well understood, one explanation could be that fewer eddy currents are induced by neighboring turns of the resonance coil 20. For example, a simulation with a substantially high Q-factor was achieved for a single turn coil resonator, as will be discussed in further detail infra.

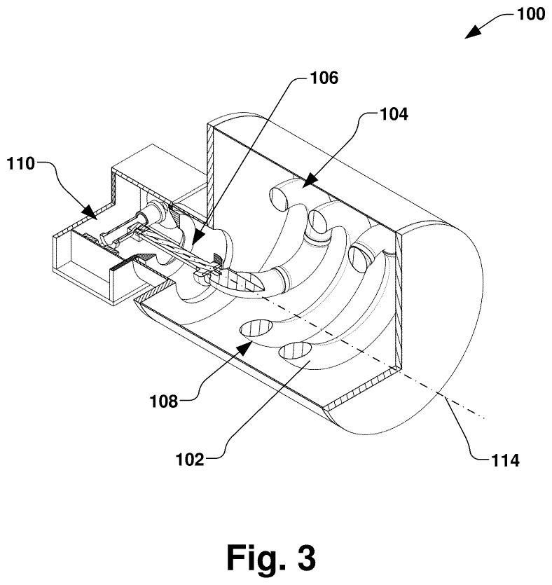

In accordance with various example aspects of the present disclosure, FIG. 3 illustrates a resonator 100, wherein the resonator comprises a tube 102 that is electrically conductive and generally defines a coil 104 having an electrode portion 106 and a coil portion 108. In the example shown in FIG. 3, the tube 102 takes a solid form (e.g., a solid rod). In other examples, while not shown, the present disclosure contemplates the tube 102 taking various other forms, such as being substantially hollow (e.g., a single-walled or multiple-walled pipe), whereby the tube can be further configured to provide cooling of the coil 104. For example, the tube 102 can be substantially hollow, whereby a cooling media (e.g., a liquid such as water or a gas such as nitrogen—not shown) can be further provided within the tube or flowed therethrough, thus facilitating a cooling of the coil 104 concurrent with an operation of the resonator 100.

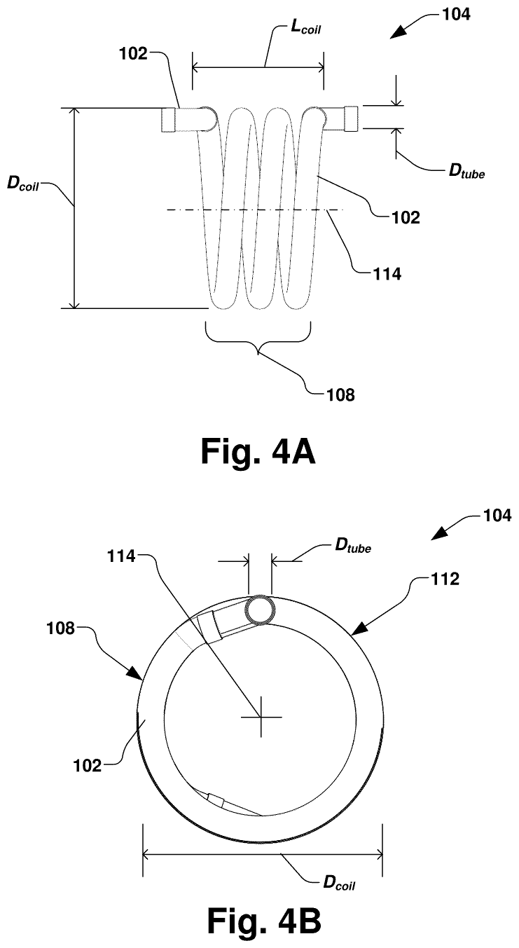

The electrode portion 106 of the coil 104 is electrically coupled to an RF electrode 110, such as the accelerator electrode 22 of FIG. 1. As illustrated in FIGS. 4A-4B, the tube 102, for example, is generally defined by a tube diameter D_{tube}. The coil portion 108, for example, has a predetermined shape 112 when viewed along a first axis 114, as illustrated in FIG. 4B, where in the present example, the predetermined shape 112 is approximately circular. The coil portion 108, for example, further defines a coil length L_{coil} illustrated in FIG. 4A when viewed perpendicular to the first axis 114. In accordance with the present disclosure, the coil portion 108 comprises three or fewer turns n of the tube about the first axis 114.

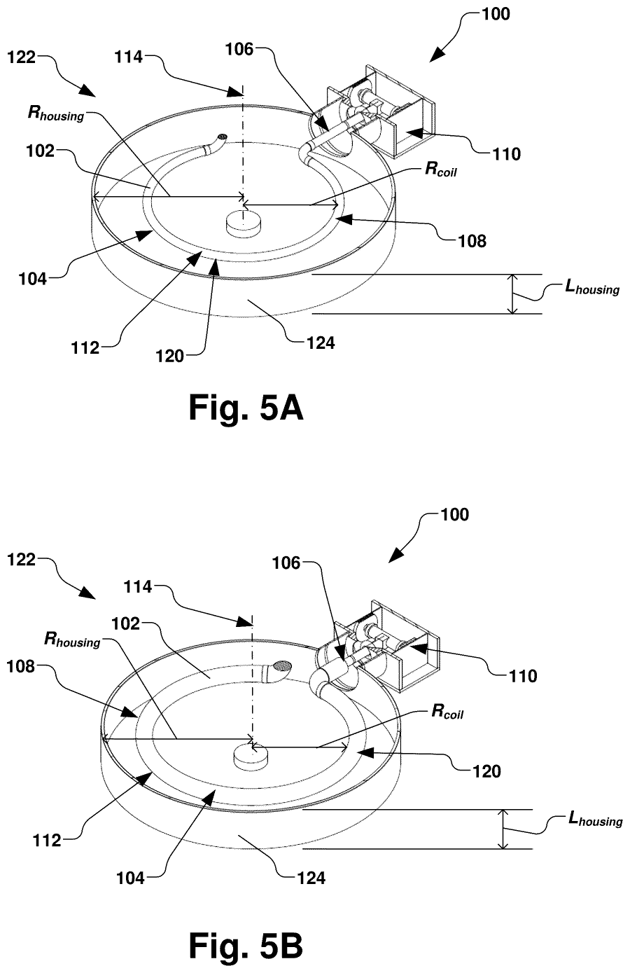

FIGS. 5A-5B, for example, illustrate a coil 120 of a single-turn resonator 122 wherein the coil portion 108 has a single turn (e.g., n less than or equal to one). In another example, the coil length L_{coil} shown in FIG. 4A is less than approximately six times the tube diameter D_{tube}, wherein six times the tube diameter D_{tube} is further less than approximately 1500 mm. The present disclosure further contemplates various other examples, such as the coil length L_{coil} being approximately equal to the tube diameter D_{tube}, and such as the coil 120 extending approximately along a plane intersecting or perpendicular to the first axis 114.

For example, a tube diameter D_{tube} of the tube 102 of the coil 120 having a single turn or less (e.g., n approximately equal to one) shown in FIGS. 5A-5B can be increased without a significant effect on the angular resonance frequency @ due to having no neighboring turns. In FIG. 4B, for example, the tube diameter D_{tube} can be further doubled (e.g., an increase from 1-inch to 2-inches), thus increasing the Q-factor by 50% and in total doubling the Q factor of the single-turn resonator 122 compared to the design shown in FIG. 2 having a plurality of turns (e.g., n greater than 1).

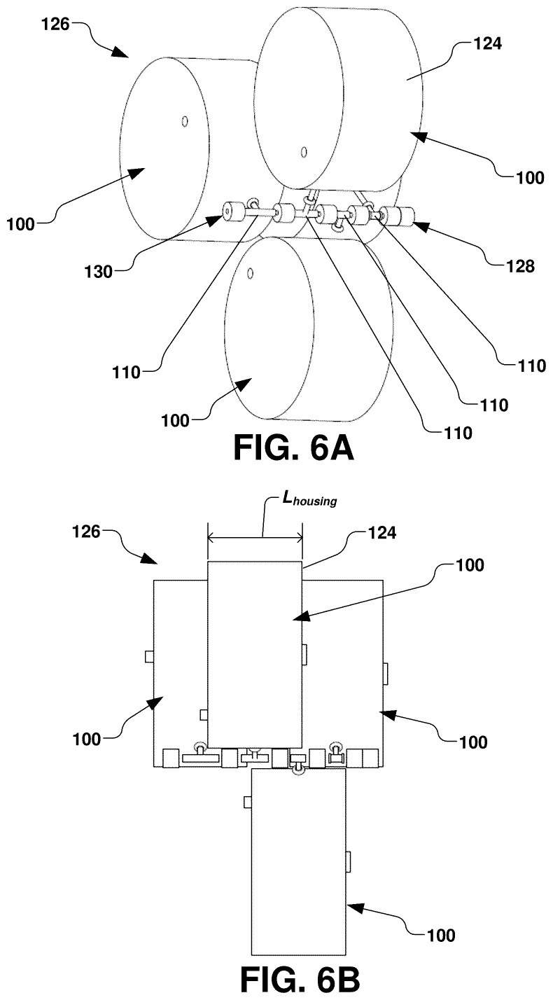

The present disclosure appreciates that the single turn of the single-turn resonator 122 can provide a coil diameter D_{coil} of the coil 104 of FIGS. 5A-5B that is substantially large. However, the present disclosure further contemplates a housing length L_{housing} of a housing 124 (e.g., a cylindrical housing) of the resonator 100 being substantially short, such as illustrated in FIGS. 6A-6B. Accordingly, a plurality of resonators 100 can be positioned to define a LINAC 126 while providing no substantial interference.

The present disclosure appreciates that one concern is for interference at an upstream end 128 of the LINAC 126, where the RF electrodes 110 are shortest, as compared to a downstream end 130 of the LINAC. Thus, in accordance with the present disclosure, several conditions can be placed on limiting dimensions of the coil 120, a geometry of the coil, a geometry of the housing 124 surrounding the coil, and/or a combination of all such dimensions and geometries. In one particular example, the present disclosure contemplates dimensions and a geometry of the coil 120 and the housing 124 surrounding the coil such that the coil and housing are substantially flat, such as illustrated in FIGS. 6A-6B.

For example, several constraints for dimensions of the coil 120 can be individually or collectively considered. For example, one constraint can be defined as:

$${L}_{coil} = 0. \qquad ( 6 )$$

In implementing constraint (6), n can be approximately equal to one, such as illustrated in the single-turn resonator 122 of FIGS. 5A-5B.

In another example, constraint (6) can be relaxed to define another constraint as:

$${L}_{coil} \leq 6 * {D}_{tube} . \qquad ( 7 )$$

For example, constraint (7) can be implemented where n is approximately equal to 3 turns, and assuming a spacing between turns is less than or equal to D_{tube}, a high Q factor can be advantageously achieved. Another constraint can be defined as:

$${L}_{coil} < {D}_{coil} . \qquad ( 8 )$$

Any of constraints (6), (7), or (8) are contemplated to advantageously achieve a high Q factor using any number (or fractional number) of turns n of the coil 120.

In accordance with another example, constraints for the housing length L_{housing} of the housing 124 can be defined as:

$${L}_{housing} \leq \frac{{R}_{housing}}{2} , or \qquad ( 9 )$$

$${L}_{housing} \leq 1.5 * {R}_{coil} , \qquad ( 10 )$$

where R_{housing} is the radius of the housing 124, and R_{coil} is the radius of the coil 120. Constraint (10), for example, limits the dimensions with the housing 124 to the dimensions of the coil 120.

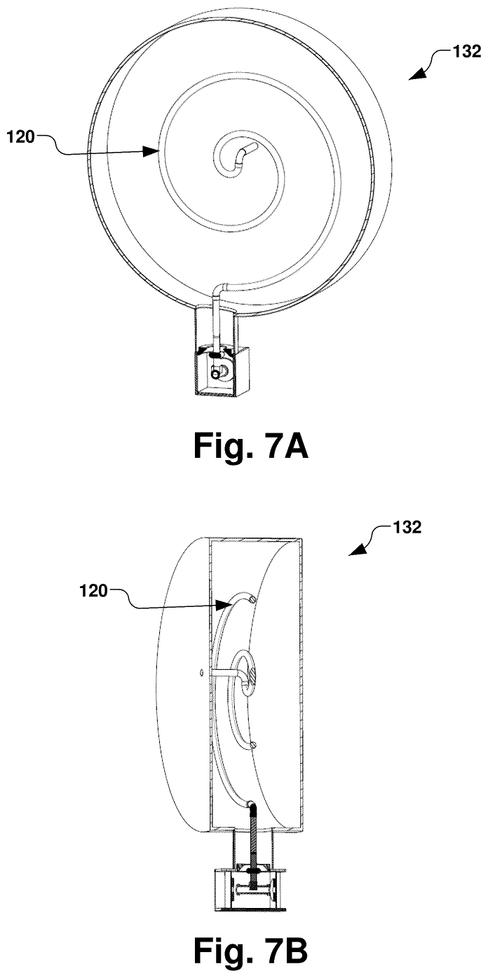

The present disclosure further contemplates various geometries of the coil 120 for a single turn coil resonator, such as the geometry of the having a racetrack, ellipse, or a distorted loop shape when viewed along the first axis 114 of FIG. 4B, for example. FIGS. 7A-7B illustrate a spiral geometry 132 of the coil 120 in another example. In yet another example, a design having a low number of turns (e.g., n ranging between 2 and 3) can have large spacings between the turns. Such a design may provide a slightly lower Q value than the single turn design (n=1) discussed above, but be large enough to provide sufficient RF amplitudes for desired ion implantation.

Further, the present disclosure contemplates constraints such as:

$${L}_{coil} \leq 6 * {D}_{tube} \leq 1500 mm . \qquad ( 11 )$$

Limits in the plane normal to first axis 114 can be provided for the coil diameter D_{coil} of the coil 120 being less than approximately 1500 mm and/or maximum dimensions of the housing length L_{housing} of the housing 124 being approximately 2000 mm. The present disclosure further appreciates that positioning the coil 120 too close to the wall of the housing 124 can increase induction of eddy currents and therefore leading to power loss and lowering of the Q factor.

Although the disclosure has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the disclosure. In addition, while a particular feature of the disclosure may have been disclosed with respect to only one of several embodiments, such feature may be combined with one or more other features of the other embodiments as may be desired and advantageous for any given or particular application.

What is claimed is:

1. A resonator for an RF linear accelerator, the resonator comprising:
an electrode configured to accelerate ions; and
a tube that is electrically conductive and comprises an electrode portion and a coil, wherein the electrode portion is electrically coupled to the electrode, and wherein the tube is generally defined by a tube diameter D_{tube}, wherein the coil has a predetermined shape when viewed along a first axis, and wherein the coil defines a coil length L_{coil} when viewed perpendicular to the first axis, and wherein the coil comprises three or fewer turns n of the tube about the first axis, and wherein the coil length L_{coil} is less than approximately six times the tube diameter D_{tube}, and wherein the tube diameter D_{tube} is less than approximately 1500 mm.

2. The resonator of claim 1, wherein the coil extends helically about the first axis over the coil length L_{coil}.

3. The resonator of claim 1, wherein the predetermined shape is one of curvilinear, circular, or spiral.

4. The resonator of claim 1, wherein the coil length L_{coil} is approximately equal to the tube diameter D_{tube}.

5. The resonator of claim 1, wherein n is approximately one.

6. The resonator of claim 1, further comprising a housing, wherein at least the coil of the tube is disposed within the housing, and wherein the electrode is disposed external to housing.

7. The resonator of claim 6, wherein the housing has a housing length L_{housing} when viewed perpendicular to the first axis, and wherein the housing length L_{housing} is less than approximately 2000 mm.

8. The resonator of claim 7, wherein the coil has a coil radius R_{coil} when viewed along the first axis, and wherein the housing length L_{housing} is less than or equal to approximately 1.5 times the coil radius R_{coil}.

9. The resonator of claim 7, wherein the housing has a housing radius R_{housing} when viewed along the first axis, and wherein the housing length L_{housing} is less than or equal to approximately 0.5 times the housing radius R_{housing}.

10. The resonator of claim 1, wherein the electrode portion of the tube extends approximately along the first axis from the coil to the electrode.

11. The resonator of claim 1, wherein the electrode portion of the tube extends approximately perpendicular to the first axis from the coil to the electrode.

12. A resonator for an RF linear accelerator, the resonator comprising:
a housing defining a housing volume;
an electrode configured to accelerate ions, wherein the electrode is disposed external to the housing volume; and
a tube that is electrically conductive and comprises an electrode portion and a coil, wherein the electrode portion is electrically coupled to the electrode, and wherein the tube is generally defined by a tube diameter D_{tube}, wherein the coil has a predetermined shape when viewed along a first axis and is disposed within the housing volume, wherein the electrode portion of the tube extends approximately along the first axis from the coil to the electrode, wherein the coil defines a coil length L_{coil} when viewed perpendicular to the first axis, and wherein the coil comprises three or fewer turns n of the tube about the first axis, and wherein the coil length L_{coil} is less than approximately six times the tube diameter D_{tube}, and wherein six times the tube diameter D_{tube} is less than approximately 1500 mm.

13. The resonator of claim 12, wherein the housing has a housing length L_{housing} when viewed perpendicular to the first axis, wherein the housing length L_{housing} is less than approximately 2000 mm.

14. The resonator of claim 12, wherein the coil has a coil radius R_{coil} when viewed along the first axis, wherein the housing has a housing length L_{housing} when viewed perpendicular to the first axis, and wherein the housing length L_{housing} is less than or equal to approximately 1.5 times the coil radius R_{coil}.

15. The resonator of claim 12, wherein the housing has a housing radius R_{housing} when viewed along the first axis, wherein the housing has a housing length L_{housing} when viewed perpendicular to the first axis, and wherein the housing length L_{housing} is less than or equal to approximately 0.5 times the housing radius R_{housing}.

16. The resonator of claim 12, wherein the coil extends helically about the first axis over the coil length L_{coil}.

17. The resonator of claim 12, wherein the predetermined shape is one of curvilinear, circular, or spiral.

18. A resonator for an RF linear accelerator, the resonator comprising:
a housing defining a housing volume;
an electrode configured to accelerate ions, wherein the electrode is disposed external to the housing volume; and
a tube that is electrically conductive and comprises an electrode portion and a coil, wherein the electrode portion is electrically coupled to the electrode, and wherein the tube is generally defined by a tube diameter D_{tube}, wherein the coil has a predetermined shape when viewed along a first axis and is disposed within the housing volume, wherein the electrode portion of the tube extends approximately perpendicular to the first axis from the coil to the electrode, wherein the coil defines a coil length L_{coil} when viewed perpendicular to the first axis, wherein the coil comprises between zero and one turns n of the tube about the first axis, and wherein the tube diameter D_{tube} is less than approximately 1500 mm.

19. The resonator of claim 18, wherein the predetermined shape is one of curvilinear, circular, or spiral.

20. The RF linear accelerator of claim 19, wherein the coil has a coil radius R_{coil} when viewed along the first axis, wherein the housing has a housing length L_{housing} when viewed perpendicular to the first axis, and wherein the housing length L_{housing} is less than or equal to approximately 1.5 times the coil radius R_{coil}.
